(19) United States
(12) Patent Application Publication
(10) Pub. No.: US 2025/0344197 A1
(43) Pub. Date: Nov. 6, 2025

(54) ASYMMETRIC RESOURCE ALLOCATION IN WIRELESS COMMUNICATION SYSTEMS

(71) Applicant: T-MOBILE INNOVATIONS LLC, Overland Park, KS (US)

(72) Inventor: William M. SHVODIAN, McLean, VA (US)

(21) Appl. No.: 18/654,831

(22) Filed: May 3, 2024

(51) Int. Cl. H04W 72/0457; H04W 56/00; H04W 72/51

(52) U.S. Cl. CPC H04W 72/0457; H04W 56/0015; H04W 72/51

(57) ABSTRACT

Embodiments of the present disclosure are directed to systems and methods for allocating asymmetric channel resources to a user equipment (UE). In order to prevent the inadvertent rejection of incompatible UEs, a base station indicates equal channel widths for the uplink and downlink and smaller initial bandwidth parts. Based on a determination that a particular UE supports asymmetric downlink and uplink channel allocations, a second bandwidth part can be allocated to the UE, making the total channel resources on one link unequal to the total channel resources on the other link.

### SUMMARY

The present disclosure is directed to allocating asymmetric resources to a user equipment (UE) in a wireless communication environment, substantially as shown and/or described in connection with at least one of the Figures, and as set forth more completely in the claims.

According to various aspects of the technology, a particular set of signaling is exchanged with a UE in order for a base station to utilize an asymmetric resource allocation; that is, an allocation of downlink resources that is different than the allocation of uplink resources. Communicating asymmetric channel bandwidths in synchronization signaling can cause many UEs to reject the cell because if a UE is not configured to communicate using asymmetric bandwidths. By communicating a wider channel bandwidth in the synchronization signaling and a narrower initial bandwidth part, symmetric-only UEs may utilize the cell; however, for UEs that support asymmetric allocations, the cell can subsequently allocate a second bandwidth part in the downlink or uplink based on UE-specific capabilities.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIGS. 3A-3B illustrate channel resource allocations for use with the present disclosure; and

FIG. 4 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz-3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, modern wireless communication systems have a prescribed amount of channel bandwidth available for use with wireless client devices (aka UEs). Whether limited by a license or an unlicensed restriction, it is not uncommon for available channel widths to be available in non-standardized amounts. International standards such as 3GPP 5G or 802.11 standards provide for standard channel widths; for example, 5G standards presently provide for standard widths mostly in increments of 5 or 10 MHz. While base stations may have flexibility to be configured and certified with custom filters to transmit on non-standard channel widths, UEs do not.

Conventionally, a network operator has two options for attempting to utilize irregular spectrum. A first option includes using the next wider channel bandwidth with PRB blanking on the downlink and the next smaller channel bandwidth on the uplink, providing for unequal channel widths in synchronization signaling; however, UEs that do not support unequal (i.e., asymmetric) channel widths may reject the cell during cell search and selection. A second option includes providing for equal channel widths in the synchronization signaling that uses a channel width that is the next-smaller standard-provided width (e.g., if an operator has 6 MHz, it would signal a downlink channel width of 5 MHz and an uplink channel width of 5 MHz); while the equal channel width insures maximum computability with UEs, it is inefficient because it does not use the last 1 MHz of available spectrum.

Unlike conventional solutions, the present disclosure is directed to allocating asymmetric channel resources to UEs that are capable, without turning away those that are not capable. In order to accomplish this, equal standard-width downlink and uplink channel widths are communicated in synchronization signaling and a smaller standard-width initial bandwidth part for downlink and uplink are also communicated. If and only if it is determined that a UE is capable of asymmetric channel allocations, a second wider bandwidth part is allocated to the UE in either the downlink or the uplink such that the allocated downlink channel resources is not equal to the allocated uplink channel resources.

Accordingly, a first aspect of the present disclosure is directed to a system for allocating asymmetric channel resources to a user equipment (UE) in a wireless communication system. The system comprises one or more antenna elements configured to transmit one or more downlink signals from the base station to one or more UEs located in a geographic coverage area. The system further comprises one or more computer processing components configured to perform operations comprising causing transmission of one or more synchronization signals to the geographic coverage area indicating that each of a downlink channel and an uplink channel have a first channel bandwidth. The operations further comprise causing transmission of one or more synchronization signals to the geographic coverage area indicating that an initial bandwidth part for each of the downlink channel and the uplink channel. The operations further comprise receiving a first capability message from a first UE indicating it supports asymmetric bandwidth combinations. The operations further comprise allocating, based on the first capability message, a second bandwidth part to a first link and the initial bandwidth part to a second link, the second bandwidth part being greater than the initial bandwidth part.

A second aspect of the present disclosure is directed to a method for allocating asymmetric channel resources to a user equipment (UE) in a wireless communication system. The method comprises transmitting one or more synchronization signals to geographic service area indicating a downlink channel bandwidth, an uplink channel bandwidth, an initial downlink bandwidth part, and an initial uplink bandwidth part, the downlink channel bandwidth being equal to the uplink channel bandwidth, wherein each of the initial downlink bandwidth part and the initial uplink bandwidth part have a bandwidth less than each of the downlink channel bandwidth and the uplink channel bandwidth. The method further comprises allocating, based on said determination, a second downlink bandwidth part to the UE and the initial uplink bandwidth part to the UE, wherein the second downlink bandwidth part is greater than the initial uplink bandwidth part.

Another aspect of the present disclosure is directed to a non-transitory computer readable media having instructions stored thereon that, when executed by one or more computer processing components, cause the one or more computer processing components to perform a method for allocating asymmetric channel resources to a user equipment (UE) in a wireless communication system. The method comprises transmitting one or more synchronization signals to geographic service area indicating a downlink channel bandwidth, an uplink channel bandwidth, an initial downlink bandwidth part, and an initial uplink bandwidth part, the downlink channel bandwidth being equal to the uplink channel bandwidth, wherein each of the initial downlink bandwidth part and the initial uplink bandwidth part have a bandwidth less than each of the downlink channel bandwidth and the uplink channel bandwidth. The method further comprises determining a UE is capable of asymmetric channel resource allocations. The method further comprises allocating, based on said determination, a second downlink bandwidth part to the UE and the initial uplink bandwidth part to the UE, wherein the second downlink bandwidth part is greater than the initial uplink bandwidth part.

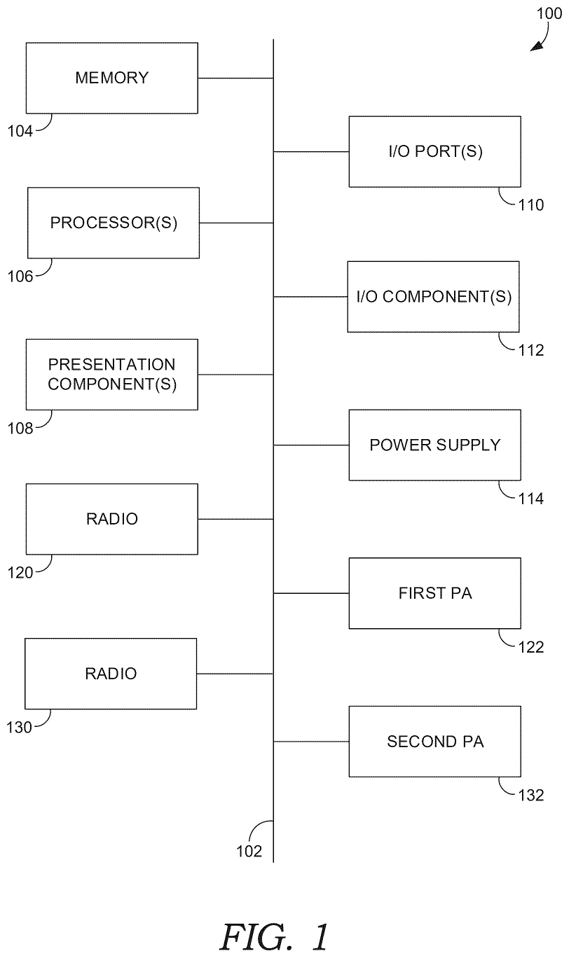

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

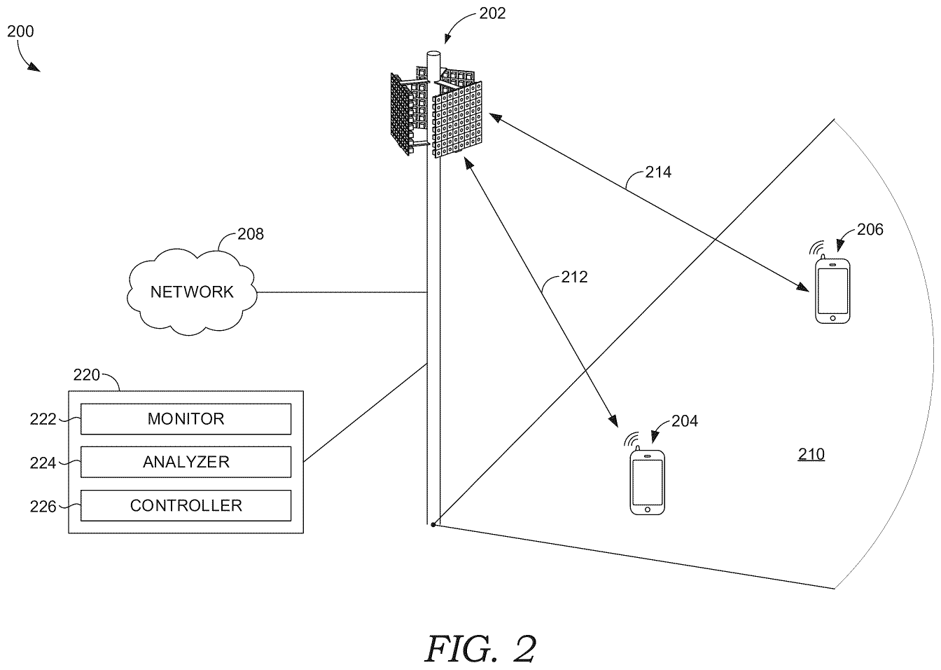

Turning now to FIG. 2, an exemplary network environment is illustrated in which implementations of the present disclosure may be employed. Such a network environment is illustrated and designated generally as network environment 200. At a high level the network environment 200 comprises one or more UEs, one or more base stations, and one or more networks. Though each of a first UE 204 and a second UE 206 are illustrated as cellular phones, a UE suitable for implementations with the present disclosure may be any computing device having any one or more aspects described with respect to FIG. 1. Similarly, though a base station 202 is illustrated as a macro cell on a cell tower, any scale or form of access point acting as a transceiver station for wirelessly communicating with a UE, including small cells, pico cells, Wi-Fi access points (e.g., routers or mesh networks), and the like, are suitable for use with the present disclosure.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells, which may or may not overlap. An example of such a cell is cell 210, in which the base station 202 is configured to wirelessly communicate with the first UE 204 using a first wireless connection 212 and the second UE 206 using a second wireless connection 214. Using any radio access technology selected by a mobile network operator (e.g., 4G, 5G, 6G, 802.11x, and the like), the base station may transmit and receive wireless signals using one or more antenna elements. Each cell, such as the cell 210 may have pre-configured maximum channel bandwidths available; for example, the cell 210 may have 6 MHz of licensed spectrum bandwidth that may be used to facilitate downlink and uplink communications with UEs in the cell 210. In aspects of the present disclosure, the maximum channel bandwidth available to the cell 210 may be irregular; that is, it may be in an amount that is not considered a standard channel bandwidth (e.g., 5, 10, 15, 20, 25, 30, 40, 50, 60, 70, 80, 90, or 100 MHz in the sub-6 GHz frequency range 1, and 50, 100, 200, or 400 MHz in the over-6 GHz frequency range 2). In other aspects, the maximum channel bandwidth may be an amount that is greater than the smallest standard channel bandwidth (e.g., greater than 5 MHz in FR1 or greater than 50 MHz in FR2).

The base station 202 is configured to communicate one or more synchronization signals to the cell 210 in order to provide UEs with information that they need in order to perform cell search, selection, and attachment. In a 5G deployment, the one or more synchronization signals may comprise, for example, a master information block (MIB) and one or more system information block (SIB) messages. Included in the one or more synchronization signals, the base station 202 may communicate one or more of a downlink channel bandwidth, an uplink channel bandwidth, an initial downlink bandwidth part, and an initial uplink bandwidth part. The base station 202 of the present disclosure will communicate a downlink channel bandwidth that is equal to the uplink channel bandwidth. If utilized in the one or more synchronization signals, the base station 202 will communicate that the initial downlink bandwidth part and the initial uplink bandwidth part are less than or equal to the downlink/uplink channel bandwidth. In some aspects, the base station 202 may also communicate that the initial downlink bandwidth part is equal to the initial uplink bandwidth part. In aspects of the present disclosure where the cell 210 is allocated an irregular channel bandwidth, the base station 202 will utilize the one or more synchronization signals to indicate that the downlink and uplink channel bandwidth is equal to the first standardized channel bandwidth that is the next greater width than the irregular channel bandwidth and an initial bandwidth part that is the next narrower width than the irregular channel bandwidth; for example, if the base station 202 has a 6 MHz channel bandwidth available for cell 210 in FR1, the one or more synchronization signals would indicate that the uplink and downlink channel bandwidths are both equal to 10 MHz and the initial bandwidth parts for each of the downlink and uplink channel are equal to 5 MHz.

Each base station of the one or more base stations may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In order to make determinations regarding the use of asymmetric channel bandwidths, the network environment comprises an asymmetric bandwidth engine 220. Though illustrated as a dedicated engine comprising three discrete modules, the asymmetric bandwidth engine 220 and its modules are described herein by way of their functionality and may be deployed or implemented in various ways that are consistent with the functionality described herein. For example, the asymmetric bandwidth engine 220 may take the form of one or more computer processing components at or near the base station 202 executing computer executable instructions that cause the one or more computer processing components to perform the operations described herein. The asymmetric bandwidth engine 220 may be said to comprise a monitor 222, analyzer 224, and a controller 226.

The monitor 222 is configured to receive a UE capability message from each of the first UE 204 and the second UE 206 after the base station 202 communicates the one or more synchronization signals. Relevant to the present disclosure, the UE capability message(s) comprise an indication whether a particular UE is capable of asymmetric channel allocations. In one aspect, the UE capability message may generally indicate support for asymmetric channels without specifying particular downlink/uplink combinations of channel bandwidths; in another aspect, the UE capability message may indicate support for particular asymmetric allocations (e.g., 10down (link)/5up (link), 20down/5up, 20down/10up, 30down/15up, etc.). The monitor 222 communicates the UE capability information to the analyzer 224

The analyzer 224 is generally configured to compare UE capabilities to channel availability, spectrum restraints, UE-specific traffic, and the like, in order to make determinations about whether or to what extent channel resources should be asymmetrically allocated to a particular UE. In one example, the analyzer 224 may receive an indication from the monitor 222 that the first UE 204 is capable of asymmetric resource allocations and that the cell 210 has an available channel bandwidth of 6 MHZ; the analyzer 224 may allocate additional resources to the first UE 204 in the downlink by allocating a larger bandwidth part of 10 MHz to the first UE 204 and blanking 4 MHz of the 10 MHz, in order to maintain the 6 MHz channel. In such an example, the first UE 204 may have asymmetric channel allocations because its downlink bandwidth part is 10 MHz and its uplink bandwidth part continues to be the initial bandwidth part width of 5 MHz. In another example, the analyzer 224 may have a standardized channel bandwidth available to the cell 210 and assign a greater downlink channel bandwidth to the first UE 204 based on a disproportionately high request for downlink resources (compared to uplink resources). In such an example, the analyzer 224 could allocate a larger bandwidth part (e.g., 10 MHz) to the downlink and maintain the smaller initial bandwidth part (e.g., 5 MHz) in the uplink. The allocation of the larger bandwidth part (e.g., 10 MHZ) may supplant/replace the smaller bandwidth part (e.g., 5 MHZ) without invoking carrier aggregation. The analyzer 224 is also configured to maintain symmetric resource allocations to UEs that are not capable of asymmetric resource allocations. If the analyzer 224 receives an indication from the monitor 222 that the second UE 206 is not capable of asymmetric resource allocations, then the analyzer 224 could maintain the symmetric initial bandwidth parts for the second UE 206. It is expressly conceived that the base station 202 could allocate asymmetric channel resources to the first UE 204 at the same time that the second UE 206 is allocated symmetric channel resources.

The controller 226 is generally configured to receive one or more indications from the analyzer 224 and determine how subsequent resource allocations should be communicated from the base station 202. Based on an indication from the analyzer 224 that the first UE 204 should be allocated asymmetric channel resources, the controller 226 instructs a scheduler or any other components of the base station 202 to execute the asymmetric allocation. In an aspect, the execution of the asymmetric channel resource allocation may take the form of allocating a second bandwidth part to the first UE 204. Based on an indication from the analyzer that the second UE 206 should not be allocated asymmetric channel resources, the controller 226 will not provide subsequent instructions vis-à-vis the second UE 206, causing the second UE 206 to continue being allocated its initial bandwidth parts.

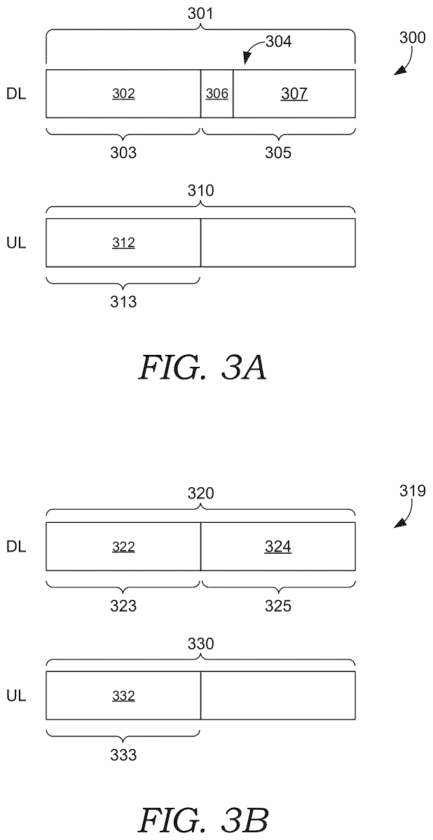

Turning now to FIGS. 3A-3B, two examples of asymmetric resource allocations are provided. With reference to FIG. 3A, a first asymmetric resource allocation 300 is provided. The first asymmetric resource allocation visually illustrates that a base station, such as the base station 202 of FIG. 2 may communicate a downlink channel bandwidth 301 and an uplink channel bandwidth 310 in one or more synchronization signals. The downlink channel bandwidth 301 is equal to the uplink channel bandwidth 310 (e.g., both are 10 MHz, both are 15 MHz, etc.). The one or more synchronization signals may further indicate that an initial downlink bandwidth part 302 having a width 303 and an initial uplink bandwidth part 312 having a width 313, wherein widths 303 and 313 may or may not be equal, but wherein each of the width 303 and the width 313 are less than the downlink channel bandwidth 301 and the uplink channel bandwidth 310 (e.g., if the downlink and uplink channel bandwidths 301 and 310 equal 10 MHz, then the widths 303 and 313 may equal 5 MHz). Based on an indication that a UE is capable of asymmetric resource allocation according to any one or more aspects described with respect to FIG. 2, a larger bandwidth part may be allocated to the UE in either the uplink or the downlink channel; for example, a second downlink bandwidth part 304 having width 305 may be allocated to the UE by replacing the initial downlink bandwidth part 302 with the larger bandwidth part (e.g., having a length of the full 10 MHz of the downlink channel bandwidth 301). In the aspect illustrated by FIG. 3A, the second downlink bandwidth part 304 may comprise an active spectrum portion 306 and a blanked portion 307, which may be particularly useful if an operator only has a license to utilize a portion of the width 305. Each of the downlink channel 301, the uplink channel 310, the initial downlink bandwidth part 302, the initial uplink bandwidth part 312, and the second bandwidth part 304 may have standards-defined bandwidths as described with respect to FIG. 2. In one non-limiting example illustrated by FIG. 3A, a base station for use with the present disclosure may be permitted to operate a 6 MHz channel; however, because at least some UEs are not configured to utilize a single 6 MHz channel, the base station may communicate a next larger standard channel bandwidth of 10 MHz for each of the downlink channel bandwidth 301 and the uplink channel bandwidth 310, and a next smaller standard bandwidth of 5 MHz as each of the initial downlink bandwidth part 302 and the initial uplink bandwidth part 312. Based on a determination that a UE is capable of asymmetric channel allocations, the second bandwidth part 304 with a width 305 of 5 MHz may be allocated to said UE with the first portion 306 (1 MHz) containing active physical resource blocks and with the second portion 307 (4 MHz) being blanked; this may be carried out by replacing the allocation of the smaller initial downlink bandwidth part 302 with an allocation of the larger bandwidth part having a length of the initial downlink bandwidth part 302 plus the second downlink bandwidth part 304.

Turning now to FIG. 3B, a second asymmetric resource allocation 319 is provided. The second asymmetric resource allocation visually illustrates that a base station, such as the base station 202 of FIG. 2 may communicate a downlink channel bandwidth 320 and an uplink channel bandwidth 330 in one or more synchronization signals. The downlink channel bandwidth 320 is equal to the uplink channel bandwidth 330 (e.g., both are 10 MHz, both are 15 MHz, etc.). The one or more synchronization signals may further indicate that an initial downlink bandwidth part 322 having a width 323 and an initial uplink bandwidth part 332 having a width 333, wherein widths 323 and 333 may or may not be equal, but wherein each of the width 323 and the width 333 are less than the downlink channel bandwidth 320 and the uplink channel bandwidth 330 (e.g., if the downlink and uplink channel bandwidths 320 and 330 equal 10 MHz, then the widths 323 and 333 may equal 5 MHz). Based on an indication that a UE is capable of asymmetric resource allocation according to any one or more aspects described with respect to FIG. 2, a larger bandwidth part may be allocated to the UE in either the uplink or the downlink channel; for example, a second downlink bandwidth part 324 having width 325 may be allocated to the UE by replacing the initial downlink bandwidth part 322 with the larger bandwidth part (e.g., having a length of the full 10 MHz of the downlink channel bandwidth 320). In the aspect illustrated by FIG. 3B, the second downlink bandwidth part 304 may comprise a second width of usable channel 325 based on, for example, said UE requesting disproportionately greater downlink channel resources. Each of the downlink channel 320, the uplink channel 330, the initial downlink bandwidth part 322 the initial uplink bandwidth part 332, and the second bandwidth part 324 may have standards-defined bandwidths as described with respect to FIG. 2. In one non-limiting example illustrated by FIG. 3B, a base station for use with the present disclosure may be permitted to operate a 10 MHz channel; however, in order to more efficiently use spectrum, the base station may communicate a larger standard channel bandwidth of 10 MHz for each of the downlink channel bandwidth 320 and the uplink channel bandwidth 330, and a smaller standard bandwidth of 5 MHz as each of the initial downlink bandwidth part 322 and the initial uplink bandwidth part 332. Based on a determination that a UE is capable of asymmetric channel allocations and requires greater downlink resources, the second bandwidth part 324 with a width 325 of 5 MHz may be allocated to said UE (e.g., by replacing the allocation of the smaller initial downlink bandwidth part 322 with an allocation of the larger bandwidth part having a length of the initial downlink bandwidth part 322 plus the second downlink bandwidth part 324).

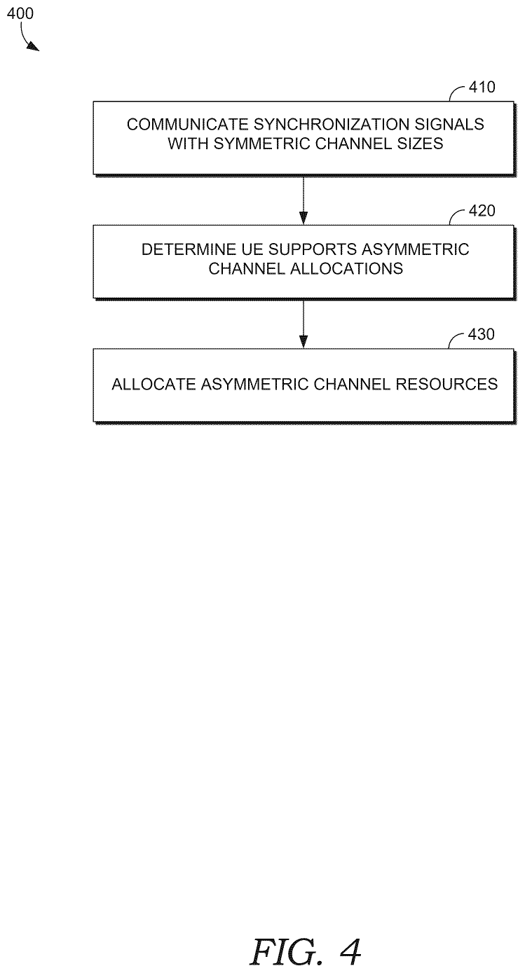

Turning now to FIG. 4, a flow chart representing a method 400 is provided. Generally the method 400 may be used by a base station, such as the base station 202 of FIG. 2, to make asymmetric channel resource allocations to a user equipment (UE). At a first step, the base station communicates one or more synchronization signals that comprise a downlink channel bandwidth that equals an uplink channel bandwidth, and initial downlink and uplink bandwidth parts, wherein the initial bandwidth parts have a narrower width than the channel bandwidth, according to any one or more aspects described with respect to FIGS. 2-3B. At a second step 420, it is determined that a UE supports asymmetric channel allocations, which may be based on a UE capability message sent to the base station or based on a query of an identifier associated with the UE that may be used to fetch pre-stored UE capabilities, according to any one or more aspects described with respect to FIGS. 2-3B. At a third step 430, asymmetric channel resources are allocated to a UE determined to be capable of supporting said allocation at step 420. According to any one or more aspects described with respect to FIGS. 2-3B, the allocation of the asymmetric channel resources in step 430 may comprise allocating a second bandwidth part in either the downlink or uplink such that the allocated channel width in the downlink is not equal to the allocated channel width in the uplink.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for allocating asymmetric channel resources to a user equipment (UE) in a wireless communication system, the system comprising:
one or more antenna elements configured to transmit one or more downlink signals from a base station to one or more UEs located in a geographic coverage area; and
one or more computer processing components configured to perform operations comprising:
causing transmission of one or more synchronization signals to the geographic coverage area indicating that each of a downlink channel and an uplink channel have a first channel bandwidth and an initial bandwidth part for each of the downlink channel and the uplink channel;
receiving a first capability message from a first UE indicating it supports asymmetric bandwidth combinations; and
allocating, based on the first capability message, a second bandwidth part to a first link and the initial bandwidth part to a second link, the second bandwidth part being greater than the initial bandwidth part.

2. The system of claim 1, wherein the first link is the downlink and the second link is the uplink.

3. The system of claim 2, wherein the allocating is further based on a determination that the base station is capable of utilizing a second channel bandwidth having a width between the first channel bandwidth and the initial bandwidth part.

4. The system of claim 3, wherein each of the first channel bandwidth and the initial bandwidth part are standard bandwidths.

5. The system of claim 4, wherein the second channel bandwidth is a non-standard bandwidth.

6. The system of claim 5, wherein the first UE is not configured to use a bandwidth part in the uplink equal to the second channel bandwidth.

7. The system of claim 5, wherein the base station is configured to communicate downlink signals using the first channel bandwidth, and wherein a portion of the first channel bandwidth that is greater than the second channel bandwidth comprises blanked physical resource blocks.

8. The system of claim 2, wherein the allocating is further based on a determination that the first UE requires a downlink resource allocation that is greater than an uplink resource allocation.

9. The system of claim 2, wherein the operations further comprise:
receiving a second capability message from a second UE in the geographic coverage area indicating it does not support asymmetric bandwidth combinations; and
allocating, based on the second capability message, the initial bandwidth part to each of a downlink and an uplink associated with the second UE.

10. The system of claim 1, wherein the first link is the uplink and the second link is the downlink.

11. A method for allocating asymmetric channel resources to a user equipment (UE) in a wireless communication system, the method comprising:
transmitting one or more synchronization signals to geographic service area indicating a downlink channel bandwidth, an uplink channel bandwidth, an initial downlink bandwidth part, and an initial uplink bandwidth part, the downlink channel bandwidth being equal to the uplink channel bandwidth, wherein each of the initial downlink bandwidth part and the initial uplink bandwidth part have a bandwidth less than each of the downlink channel bandwidth and the uplink channel bandwidth;
determining a UE is capable of asymmetric channel resource allocations; and
allocating, based on said determination a second downlink bandwidth part to the UE and the initial uplink bandwidth part to the UE, wherein the second downlink bandwidth part is greater than the initial uplink bandwidth part.

12. The method of claim 11, wherein determining the UE is capable of asymmetric channel resource allocations is based on a UE capability message received from the UE.

13. The method of claim 11, wherein determining the UE is capable of asymmetric channel resources allocations is based on receiving an indicator associated with the UE and using said indicator to query a pre-stored set of UE capabilities.

14. The method of claim 11, wherein each of the downlink channel bandwidth, the uplink channel bandwidth, the initial downlink bandwidth part, and the initial uplink bandwidth part have standards-defined bandwidths.

15. The method of claim 14, wherein at least a portion of the second downlink bandwidth part comprises blanked physical resource blocks.

16. A non-transitory computer readable media having instructions stored thereon that, when executed by one or more computer processing components, cause the one or more computer processing components to perform a method for allocating asymmetric channel resources to a user equipment (UE) in a wireless communication system, the method comprising:
transmitting one or more synchronization signals to geographic service area indicating a downlink channel bandwidth, an uplink channel bandwidth, an initial downlink bandwidth part, and an initial uplink bandwidth part, the downlink channel bandwidth being equal to the uplink channel bandwidth, wherein each of the initial downlink bandwidth part and the initial uplink bandwidth part have a bandwidth less than each of the downlink channel bandwidth and the uplink channel bandwidth;
determining a UE is capable of asymmetric channel resource allocations; and
allocating, based on said determination, a second downlink bandwidth part to the UE and the initial uplink bandwidth part to the UE, wherein the second downlink bandwidth part is greater than the initial uplink bandwidth part.

17. The non-transitory computer readable media of claim 16, wherein determining the UE is capable of asymmetric channel resource allocations is based on a UE capability message received from the UE.

18. The non-transitory computer readable media of claim 16, wherein determining the UE is capable of asymmetric channel resources allocations is based on receiving an indicator associated with the UE and using said indicator to query a pre-stored set of UE capabilities.

19. The non-transitory computer readable media of claim 16, wherein each of the downlink channel bandwidth, the uplink channel bandwidth, the initial downlink bandwidth part, and the initial uplink bandwidth part have standards-defined bandwidths.

20. The non-transitory computer readable media of claim 16, wherein at least a portion of the second downlink bandwidth part comprises blanked physical resource blocks.
